(19) United States
(12) Patent Application Publication
(10) Pub. No.: US 2022/0067498 A1
(43) Pub. Date: Mar. 3, 2022

(54) APPARATUS AND METHOD WITH NEURAL NETWORK OPERATION

(71) Applicant: SAMSUNG ELECTRONICS CO., LTD., Suwon-si (KR)

(72) Inventor: Seongwook PARK, Ulsan (KR)

(73) Assignee: SAMSUNG ELECTRONICS CO., LTD., Suwon-si (KR)

(21) Appl. No.: 17/162,326

(22) Filed: Jan. 29, 2021

(30) Foreign Application Priority Data
Sep. 3, 2020 (KR) 10-2020-0112302

(51) Int. Cl. G06N 3/063; G06F 9/38; G06F 12/1027; G06F 9/54

(52) U.S. Cl. CPC G06N 3/0635; G06F 9/544; G06F 12/1027; G06F 9/3802

(57) ABSTRACT

A neural network operation apparatus includes: a buffer configured to store data for a neural network operation; a processor configured to change a fetching order of the data based on an observation range for fetching the data and a size of the buffer; and a first multiplexer configured to multiplex at least a portion of the data having the changed fetching order.

### CROSS-REFERENCE TO RELATED APPLICATIONS

This application claims the benefit under 35 USC § 119(a) of Korean Patent Application No. 10-2020-0112302 filed on Sep. 3, 2020 in the Korean Intellectual Property Office, the entire disclosure of which is incorporated herein by reference for all purposes.

### BACKGROUND

### 1. Field

The following description relates to an apparatus and method with a neural network operation.

### 2. Description of Related Art

To achieve a high rate of operation, a neural processor may include a number of operation processors (for example, multiplier-and-accumulators (MACs)) and as many buffers.

The neural processor may have a structure for selectively transferring data to the plurality of operation processors using multiplexers connected to the buffers.

When the performance of a multiplexer increases, the selection range of processors to which a single buffer may transfer data may be widened, such that the rate of operation and the flexibility of operation may increase. However, while the rate of operation and the flexibility of operation may increase, the widening of the selection range of processors may greatly increase a cost for hardware area and power consumption.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a neural network operation apparatus includes: a buffer configured to store data for a neural network operation; a processor configured to change a fetching order of the data based on an observation range for fetching the data and a size of the buffer; and a first multiplexer configured to multiplex at least a portion of the data having the changed fetching order.

The observation range may include a first observation range for observing data of different channels and a second observation range for observing data of the same channel.

The first observation range may be a look-ahead observation range, and the second observation range may be a look-aside observation range.

The apparatus may include: a second multiplexer configured to multiplex an output of the first multiplexer.

The apparatus may include: a multiply-accumulate (MAC) operator configured to perform a MAC operation based on an output of the second multiplexer.

The second multiplexer may be further configured to multiplex a number of pieces of the data determined based on a first observation range for observing data of different channels and a second observation range for observing data of the same channel.

The number of first multiplexers may be determined based on a first observation range for observing data of different channels.

For the changing of the fetching order, the processor may be configured to: fetch first data from among the data, and fetch second data adjacent to the first data to a location away from the first data by a distance determined based on the observation range and the size of the buffer.

For the fetching of the second data, the processor may be configured to fetch the second data adjacent to the first data to the location away from the first data by the distance, wherein the distance is determined based on a value obtained by dividing the size of the buffer by the observation range.

The distance may be determined to be a floor function value of the value obtained by dividing the size of the buffer by the observation range.

The first multiplexer may be configured to multiplex a number of pieces of the data determined based on the observation range and the size of the buffer.

The number of pieces of the data may be determined based on a value obtained by dividing the size of the buffer by the observation range.

In another general aspect, a processor-implemented neural network operation method includes: storing data for a neural network operation in a buffer; changing a fetching order of the data based on a total number of pieces of the stored data and an observation range for fetching the data; and primarily multiplexing at least a portion of the data the fetching order of which is changed.

The observation range may include a first observation range for observing data of different channels and a second observation range for observing data of the same channel.

The first observation range may be a look-ahead observation range, and the second observation may be is a look-aside observation range.

The method may include: secondarily multiplexing the primarily multiplexed data.

The method may include: performing a multiply-accumulate (MAC) operation on the secondarily multiplexed data.

The secondarily multiplexing may include secondarily multiplexing a number of pieces of the data determined based on a first observation range for observing data of different channels and a second observation range for observing data of the same channel.

The primarily multiplexing may be performed by first multiplexers, the number of first multiplexers being determined based on a first observation range for observing data of different channels.

The changing may include: fetching first data from among the data; and fetching second data adjacent to the first data to a location away from the first data by a distance determined based on the observation range and the total number of pieces of stored data.

The fetching of the second data may include fetching the second data adjacent to the first data to the location away from the first data by the distance, wherein the distance is determined based on a value obtained by dividing the total number of pieces of stored data by the observation range.

The primarily multiplexing may include primarily multiplexing a number of pieces of the data determined based on the observation range and the total number of pieces of stored data.

The number of pieces of the data may be determined based on a value obtained by dividing the total number of pieces of stored data by the observation range.

In another general aspect, a neural network operation apparatus includes: a buffer configured to store data for a neural network operation; one or more first multiplexers each configured to multiplex a number of pieces of the data, the number of pieces being equal to a floor function value of a division of a size of the buffer by an observation range for fetching the data.

The apparatus may include a processor configured to change a fetching order of the data based on the size of the buffer and the observation range.

Other features and aspects will be apparent from the following detailed description, the drawings, and the claims.

### BRIEF DESCRIPTION OF THE DRAWINGS

FIG. 1 illustrates an example of a neural network operation apparatus.

FIG. 2 illustrates an example of a multiplexer.

FIG. 3 illustrates an example of an operation of a neural network operation apparatus.

FIG. 4 illustrates an example of an operation of a neural network operation apparatus when an observation range is 2.

FIG. 5 illustrates an example of an operation of a neural network operation apparatus when an observation range is 3.

FIG. 6 illustrates an example of an operation of a neural network operation apparatus when an observation range is 4.

FIG. 7 illustrates an example of an operation of a neural network operation apparatus when a buffer has a doubled size.

FIG. 8 illustrates an example of a flow of the operation of a neural network operation apparatus.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art, after an understanding of the disclosure of this application, may be omitted for increased clarity and conciseness.

Hereinafter, examples will be described in detail with reference to the accompanying drawings. However, various alterations and modifications may be made to the examples. Here, the examples are not construed as limited to the disclosure. The examples should be understood to include all changes, equivalents, and replacements within the idea and the technical scope of the disclosure.

The terminology used herein is for the purpose of describing particular examples only and is not to be limiting of the present disclosure. As used herein, the singular forms “a”, “an”, and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, integers, steps, operations, elements, components, numbers, and/or combinations thereof, but do not preclude the presence or addition of one or more other features, integers, steps, operations, elements, components, numbers, and/or combinations thereof. The use of the term “may” herein with respect to an example or embodiment (for example, as to what an example or embodiment may include or implement) means that at least one example or embodiment exists where such a feature is included or implemented, while all examples are not limited thereto.

Unless otherwise defined, all terms including technical and scientific terms used herein have the same meaning as commonly understood by one of ordinary skill in the art to which this disclosure pertains consistent with and after an understanding of the present disclosure. It will be further understood that terms, such as those defined in commonly-used dictionaries, should be interpreted as having a meaning that is consistent with their meaning in the context of the relevant art and the present disclosure, and will not be interpreted in an idealized or overly formal sense unless expressly so defined herein.

When describing the examples with reference to the accompanying drawings, like reference numerals refer to like constituent elements and a repeated description related thereto will be omitted. In the description of examples, detailed description of well-known related structures or functions will be omitted when it is deemed that such description will cause ambiguous interpretation of the present disclosure.

Although terms of “first” or “second” are used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. Likewise, expressions, for example, “between” and “immediately between” and “adjacent to” and “immediately adjacent to” may also be construed as described in the foregoing.

The same name may be used to describe an element included in the examples described above and an element having a common function. Unless otherwise mentioned, the descriptions on the examples may be applicable to the following examples and thus, duplicated descriptions will be omitted for conciseness.

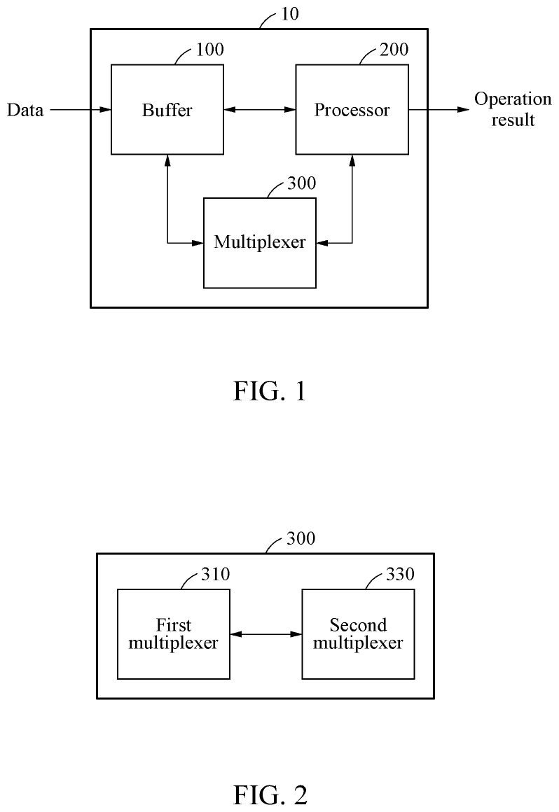

FIG. 1 illustrates an example of a neural network operation apparatus, and FIG. 2 illustrates an example of a multiplexer (e.g., a multiplexer shown in FIG. 1).

Referring to FIGS. 1 and 2, a neural network operation apparatus 10 may receive data, perform a neural network operation, and output an operation result. The neural network operation apparatus 10 may receive data and perform a predetermined neural network operation.

The data may be information in the form of characters, numbers, sounds, or pictures that may be processed by a computer. For example, the data may include text or image data. The image data may include a plurality of channels. The operation result may an inference result of the data. For example, the operation result may include a text recognition result or an image recognition result.

The neural network may include a statistical training algorithm in machine learning. The neural network may refer to a model that has an ability to solve a problem, where nodes forming the network through synaptic combinations change a connection strength of synapses through training.

The neural network may include a deep neural network (DNN). The neural network may include a convolutional neural network (CNN), a recurrent neural network (RNN), a perceptron, a feed forward (FF), a radial basis network (RBF), a deep feed forward (DFF), a long short-term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and an attention network (AN).

The neural network operation may include all operations necessary for inference using the neural network. The neural network operation may include a convolution operation. For example, the neural network operation may include a multiply-accumulate (MAC) operation for the convolution operation. The MAC operation may include multiply, add, and accumulate operations on data.

The neural network operation apparatus 10 may include a buffer 100, a processor 200, and multiplexers 300. The multiplexers 300 may include a first multiplexer 310 and a second multiplexer 330.

The neural network operation apparatus 10 may change a fetching order of data used to perform the MAC operation. The neural network operation apparatus 10 of one or more embodiments may change the fetching order of data stored in the buffer 100, thereby advantageously reducing the area occupied by multiplexers and power consumption of the operation apparatus by the multiplexers, compared to the area and the power consumption of a typical neural network operation apparatus.

For example, the neural network operation apparatus 10 of one or more embodiments may efficiently improve a method of fetching data to the buffer 100 and/or a method of fetching data from the buffer 100 in a highly integrated operator structure, thereby optimizing the hardware area and power consumption cost of the multiplexers 300 in the range not affecting the overall operation performance.

The buffer 100 may store one or more pieces of data. For example, the buffer 100 may store data for a neural network operation.

The buffer 100 may store data, where the number (e.g., the total number) of pieces of the data correspond to the size of the buffer 100. The buffer 100 may include one or more entries. The size of the buffer 100 may correspond to the number of entries. One entry may correspond to one piece of data stored in the buffer 100.

The buffer 100 may be implemented as a memory. The memory may store instructions (or programs) executable by the processor 200. For example, the instructions may include instructions to perform an operation of the processor and/or an operation of each element of the processor, where the processor 200 is configured to perform the operation and/or the operation of each element when the processor 200 executes the instructions.

The memory may be implemented as a volatile memory device or a non-volatile memory device.

The volatile memory device may be implemented as a dynamic random access memory (DRAM), a static random access memory (SRAM), a thyristor RAM (T-RAM), a zero capacitor RAM (Z-RAM), and/or a Twin Transistor RAM (TTRAM).

The non-volatile memory device may be implemented as an electrically erasable programmable read-only memory (EEPROM), a flash memory, a magnetic RAM (MRAM), a spin-transfer torque (STT)-MRAM, a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate Memory (NFGM), a holographic memory, a molecular electronic memory device), and/or an insulator resistance change memory.

The processor 200 (e.g., one or more processors) may process data stored in the memory. The processor 200 may execute computer-readable instructions stored in the memory that configure the processor 200 to perform the operation.

The processor 200 may be a hardware data processing device including a circuit having a physical structure to perform desired operations. For example, the desired operations may include instructions or codes included in a program.

For example, the hardware-implemented data processing device may include a microprocessor, a central processing unit (CPU), a processor core, a multi-core processor, a multiprocessor, an application-specific integrated circuit (ASIC), and/or a field-programmable gate array (FPGA).

The processor 200 may change a fetching order of data based on an observation range for fetching the data and the size of the buffer 100.

The observation range may be a range of data that the processor 200 refers to for fetching the data or a range of entries of the buffer 200. For example, the processor 200 may check data included in the observation range in advance and then fetch data based on values of the data or the distribution of the values of the data.

The observation range may include a first observation range for observing data of different channels and a second observation range for observing data of the same channel. For example, a first observation range may be a look-ahead observation range, and a second observation range may be a look-aside observation range.

Hereinafter, a look-ahead observation method may refer to a method of observing different pieces of data of different channel directions, and a look-aside observation method may refer to a method of observing different pieces of data in the same channel (or image or feature map).

The processor 200 may fetch first data from among the data, and fetch second data adjacent to the first data to a location away from the first data by a distance calculated based on the observation range and the size of the buffer 100.

Here, the first data and the second data being adjacent may indicate that the locations of entries stored in the buffer 100 before the fetching order is changed are adjacent.

The multiplexers 300 may perform multiplexing. Multiplexing may be an operation of selecting one of analog or digital input signals and transmitting the selected input signal to one line.

The first multiplexer 310 may multiplex at least a portion of the data the fetching order of which is changed. The second multiplexer 330 may multiplex an output of the first multiplexer 310.

The first multiplexer 310 and/or the second multiplexer 330 may include one or more multiplexers. The number of first multiplexers 310 may be determined based on a first observation range for observing data of different channels.

The first multiplexer 310 may multiplex data, the number of pieces of data being determined based on the observation range and the size of the buffer (or the number of pieces of data). The first multiplexer 310 may multiplex data, the number of pieces of data being determined based on a value obtained by dividing the size of the buffer by the observation range.

The second multiplexer 330 may multiplex data, the number of pieces of data being determined based on the first observation range for observing data of different channels and the second observation range for observing data of the same channel.

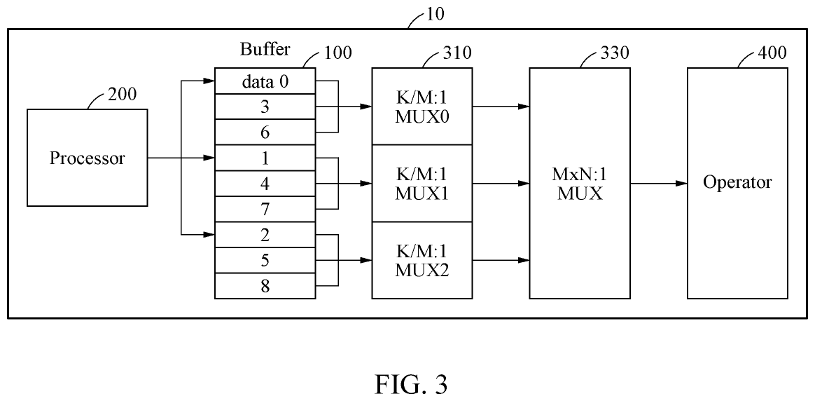

The neural network operation apparatus 10 may further include an operator (e.g., an operator 400 further discussed below) configured to perform a neural network operation based on an output of the second multiplexer 330. The operator may further include a MAC operator configured to perform a MAC operation. A non-limiting example of the MAC operator will be described in further detail below with reference to FIG. 3.

FIG. 3 illustrates an example of an operation of a neural network operation (e.g., the neural network operation apparatus of FIG. 1).

Referring to FIG. 3, the processor 200 may replace data requiring no operation processing with data requiring peripheral operation processing by expanding an observation range for the periphery of data on which an operation is performed, thereby maximizing a valid operation quantity per clock.

As described above, the observation range of the data may include a look-ahead observation range for observing data of different channels and a look-aside observation range for observing different data of the same channel.

Hereinafter, the look-ahead observation range will be referred to as M, and the look-aside observation range will be referred to as N. N and M may be determined in the process of designing hardware of the neural network operation apparatus 10. N and M may be determined by analyzing experimental data.

When the number of pieces of data stored in the buffer 100 (or the size of the buffer 100) is K, the look-aside observation range is N, and the look-ahead observation range is M, an N number of K:1 first multiplexers 310 may be needed for simultaneously accessing n pieces of data to multiplex a single piece of data in the buffer 100 unless the fetching order of the data is changed. In this example, the area and power consumption of all the multiplexers 300 may increase in proportion to K and N, in addition to the number L of buffers 100.

For example, when the structure of the multiplexers 300 becomes complex and the number of multiplexers 300 increases, the area and power consumption of the multiplexers 300 may increase. Further, the number of physical wires for connection between the buffer 100 and the multiplexers 300 and for connection between the multiplexers 300 may also increase in proportion to the number of multiplexers 300, and the connection complexity may increase in proportion to the square of the number of multiplexers 300. Accordingly, the neural network operation apparatus 10 may advantageously simplify the structure of the multiplexers 300 and reduce the number thereof.

The processor 200 of the neural network operation apparatus 10 may change a fetching pattern of the data stored in the buffer 100, thereby reducing the cost for area and power consumption of the multiplexer 300.

The processor 200 may reduce the number of multiplexers 300 by using the characteristic that N pieces of different data stored in the buffer 100 are continuous. Observation in a look-ahead direction requires accessing continuous data. Thus, the processor 200 may perform fetching such that the order of storing the data in the buffer 100 is not continuous, thereby reducing a redundant surplus area of the multiplexers 300.

The processor 200 may reduce the size of the first multiplexer 310 by changing the fetching order of the data stored in the buffer 100 so that data having no continuity are input into the first multiplexer 310.

The processor 200 may reduce the size of the first multiplexer 310 to K/M:1 through data fetching. The example of FIG. 3 shows a case where the buffer size K is 9 and the look-ahead observation range is 3. In this case, the first multiplexer 310 may be a 3:1 multiplexer. In addition, three first multiplexers 310 may be provided.

The second multiplexer 330 may multiplex the output of the first multiplexer 310. In this case, the second multiplexer 330 may need to multiplex data output from buffers other than the buffer 100 as well as the data in the buffer 100 and thus, have a size of M×N:1.

The output of the second multiplexer 330 may be input into an operator 400. The operator 400 may perform a neural network operation using the output of the second multiplexer 330.

The operator 400 may include a MAC operator. The MAC operator may perform multiplication, addition, and accumulation of two or more pieces of data.

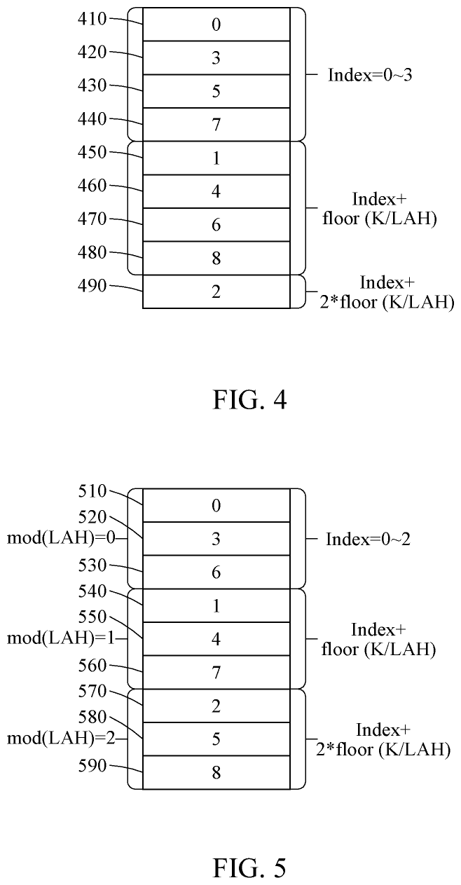

Hereinafter, non-limiting examples of the fetching operation of the neural network operation apparatus will be described in further detail below with reference to FIGS. 4 to 7.

FIGS. 4 to 6 illustrate examples of operations of the neural network operation apparatus according to various observation ranges, and FIG. 7 illustrates an example of an operation of the neural network operation apparatus when a buffer has a doubled size (e.g., two times greater than a size of a buffer in FIG. 5).

Referring to FIGS. 4 to 7, the processor 200 may change a fetching order of data stored in the buffer 100. In FIGS. 4 to 7, LAH denotes the value of a look-ahead observation range M.

The processor 200 may fetch second data adjacent to first data to a location away from the first data by a distance calculated based on an observation range and the size of the buffer 100. In detail, the processor 200 may fetch the second data adjacent to the first data to a location away from the first data by a distance calculated based on a value obtained by dividing the size of the buffer 100 by the observation range.

For example, the processor 200 may fetch the second data to a location away from the first data by a distance corresponding to a floor function value of a value obtained by dividing the size of the buffer 100 by the first observation range (or the look-ahead observation range).

The example of FIG. 4 shows a case where the look-ahead observation range M or LAH is 2. In this example, the buffer size K may be 9. In the example of FIG. 4, the processor 200 only needs to additionally access a single piece of adjacent data and thus, may fetch data at a location away by floor(K/LAH).

Therefore, if data stored in a first entry 410 of the buffer 100 is 0, the processor 200 may fetch 1 to a fifth entry 450 at a location away by floor(9/2)=4. Similarly, the processor 200 may fetch 2 to a ninth entry 490 at a location away from the fifth entry 450 by floor(9/2)=4.

Subsequently, the processor 200 may fetch the next adjacent data 3 to a second entry 420, and fetch 4 to a sixth entry 460. Similarly, the processor 200 may fetch 5 a third entry 430, and fetch 6 to a seventh entry 470.

Finally, the processor 200 may fetch 7 to a fourth entry 440, and fetch 8 to an eighth entry 480. The index represented on the right side of FIG. 4 may be an index corresponding to an entry in the buffer 100.

By changing the fetching order as shown in FIG. 4, the neural network operation apparatus 10 may reduce two 9:1 multiplexers to two 4:1 multiplexers.

The example of FIG. 5 shows a case where the look-ahead observation range is 3. In this case, the processor 200 needs to additionally access two pieces of adjacent data. Thus, the processor 200 may sequentially fetch data to entries at locations away by multiples of floor(9/3)=3.

In the example of FIG. 5, the processor 200 may fetch the first data 0 to a first entry 510, and fetch the second data 1 to a fourth entry 540 at a location away from the first data by floor(9/3)=3. The processor 200 may fetch data 2 to a location away from the fourth entry 540 by 3.

In the same manner as described above, the processor 200 may fetch data 3, 4, and 5 to a second entry 520, a fifth entry 550, and an eighth entry 580, respectively. Similarly, the processor 200 may fetch data 6, 7, and 8 to a third entry 530, a sixth entry 560, and a ninth entry 590, respectively. The index represented on the right side of FIG. 5 may be an index corresponding to an entry in the buffer 100.

By changing the fetching order as shown in FIG. 5, the neural network operation apparatus 10 may reduce three 9:1 multiplexers to three 3:1 multiplexers.

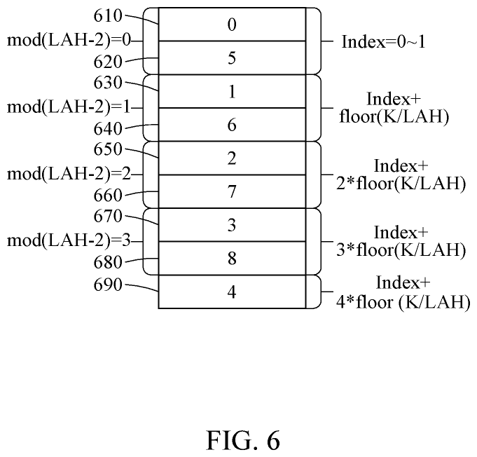

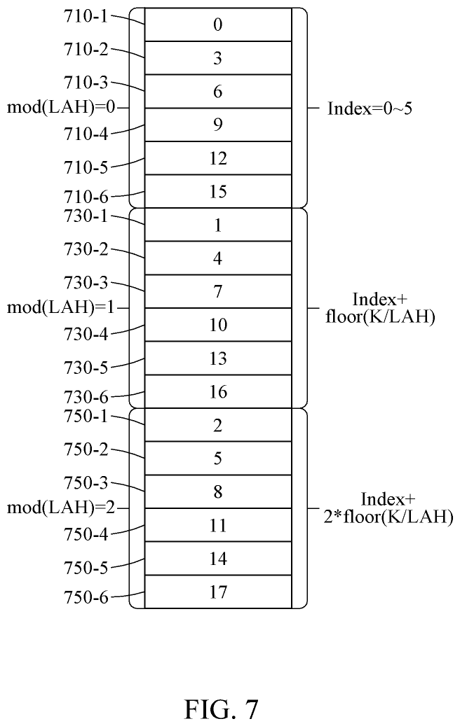

The example of FIG. 6 shows a case where the look-ahead observation range is 4. In this case, the processor 200 needs to additionally access three pieces of adjacent data. Thus, the processor 200 may sequentially fetch data to entries at locations away by multiples of floor(9/4)=2.

In detail, the processor 200 may fetch the first data 0 to a first entry 610, and fetch the second data 1 to a third entry 630 at a location away from the first data by floor(9/4)=2.

In the same manner, the processor 200 may fetch data 2, 3, and 4 to a fifth entry 650, a seventh entry 670, and a ninth entry 690, respectively. The processor 200 may fetch data 5, 6, 7, and 8 to a second entry 620, a fourth entry 640, a sixth entry 660, and an eighth entry 680, respectively. The index represented on the right side of FIG. 6 may be an index corresponding to an entry in the buffer 100.

By changing the fetching order as shown in FIG. 6, the neural network operation apparatus 10 may reduce four 9:1 multiplexers to four 2:1 multiplexers.

In some examples, the look-ahead observation range may have a value greater than 4. In this example as well, the processor 200 may fetch data in the same manner as described above with reference to FIGS. 4-6.

By fetching data as described above, the first multiplexer 310 may have a size of floor(K/LAH):1, and may have the number of first observation ranges (or look-ahead observation ranges). That is, in the example of FIG. 4, the first multiplexer 310 may be implemented as two 4:1 multiplexers. In the example of FIG. 4, the data stored in the ninth entry 490 may be directly input into the second multiplexer 330 without passing through the first multiplexer 310.

In the example of FIG. 5, the first multiplexer 310 may be implemented as three 3:1 multiplexers. In the example of FIG. 5, the buffer size of 9 is divisible by the look-ahead observation range of 3. Thus, three 3:1 multiplexers may receive data from all the entries of the buffer 100.

In the example of FIG. 6, the first multiplexer 310 may be implemented as four 2:1 multiplexers. Similar to the example of FIG. 4, the data stored in the ninth entry 690 may be directly input into the second multiplexer 330 without passing through the first multiplexer 310.

The example of FIG. 7 shows a case where the size K of the buffer 100 is 18 and the look-ahead observation range M (or LAH) is 3. In this example, the processor 200 may continuously fetch data to the extended buffer 100.

For example, the processor 200 may fetch data 0 to an entry 710-1, and fetch data 1 from the entry 710-1 to an entry 730-1 at a location away by floor(18/3)=6. Subsequently, the processor 200 may fetch data 2 to an entry 750-1.

Next, the processor 200 may fetch data 3, 4, and 5 to an entry 710-2, an entry 730-2, and an entry 750-2, respectively. Data 6 to 17 may also be fetched in the same manner as described above. The index in FIG. 7 may be an index corresponding to an entry to which data are fetched.

By changing the fetching order, the neural network operation apparatus 120 may reduce LAH 2K:1 multiplexers to LAH 2K/LAH:1 multiplexers. In the example of FIG. 7, three 18:1 multiplexers may be reduced to three 6:1 multiplexers.

In the conventional method, as the size of the buffer 100 increases, the size of the multiplexer 300 also increases, the number of wires connected per buffer 100 is 2K×LAH, which is proportional to the size of the buffer, and the complexity of the wires may also increase.

In contrast, the neural network operation apparatus 10 of one or more embodiments may reduce the size of the multiplexer 300, thereby reducing the number of wires to 1/LAH and reducing the complexity as well.

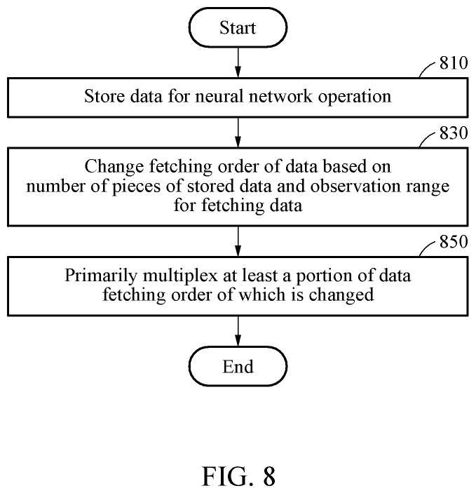

FIG. 8 illustrates an example of a flow of the operation of a neural network operation apparatus (e.g., the neural network operation apparatus of FIG. 1).

Referring to FIG. 8, in operation 810, the buffer 100 may store data for a neural network operation.

In operation 830, the processor 200 may change a fetching order of data based on an observation range for fetching the data and the number of pieces of stored data.

The observation range may include a first observation range for observing data of different channels and a second observation range for observing data of the same channel. The first observation range may be a look-ahead observation range, and the second observation range may be a look-aside observation range.

The processor 200 may fetch first data from among the data, and fetch second data adjacent to the first data to a location away from the first data by a distance calculated based on the observation range and the number of pieces of stored data.

In detail, the processor 200 may fetch the second data adjacent to the first data to a location away from the first data by a distance calculated based on a value obtained by dividing the number of pieces of stored data by the observation range. For example, the observation range may be a look-ahead observation range.

In operation 850, the first multiplexer 310 may primarily multiplex at least a portion of the data the fetching order of which is changed. The primarily fetching may be performed by first multiplexers, the number of first multiplexers being determined based on the first observation range for observing data of different channels.

The first multiplexer 310 may primarily multiplex data, the number of pieces of data being determined based on the observation range and the number of pieces of stored data. For example, the first multiplexer 310 may primarily multiplex data, the number of pieces of data being determined based on a value obtained by dividing the number of pieces of stored data by the observation range.

The second multiplexer 330 may secondarily multiplex the primarily multiplexed data. The second multiplexer 330 may secondarily multiplex a number of pieces of the data, the number of pieces of the data being determined based on the first observation range for observing data of different channels and the second observation range for observing data of the same channel.

The operator 400 may include a MAC operator. The MAC operator may perform a MAC operation on the secondarily multiplexed data.

The neural network operation apparatuses, buffers, processors, multiplexers, first multiplexers, second multiplexers, operators, neural network operation apparatus 10, buffer 100, processor 200, multiplexers 300, first multiplexer 310, second multiplexer 330, operator 400, and other apparatuses, devices, units, modules, and components described herein with respect to FIGS. 1-8 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-8 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions used herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

What is claimed is:

1. A neural network operation apparatus, comprising:
a buffer configured to store data for a neural network operation;
a processor configured to change a fetching order of the data based on an observation range for fetching the data and a size of the buffer; and
a first multiplexer configured to multiplex at least a portion of the data having the changed fetching order.

2. The apparatus of claim 1, wherein the observation range comprises a first observation range for observing data of different channels and a second observation range for observing data of the same channel.

3. The apparatus of claim 2, wherein
the first observation range is a look-ahead observation range, and
the second observation range is a look-aside observation range.

4. The apparatus of claim 1, further comprising:
a second multiplexer configured to multiplex an output of the first multiplexer.

5. The apparatus of claim 4, further comprising:
a multiply-accumulate (MAC) operator configured to perform a MAC operation based on an output of the second multiplexer.

6. The apparatus of claim 4, wherein the second multiplexer is further configured to multiplex a number of pieces of the data determined based on a first observation range for observing data of different channels and a second observation range for observing data of the same channel.

7. The apparatus of claim 1, wherein the number of first multiplexers is determined based on a first observation range for observing data of different channels.

8. The apparatus of claim 1, wherein, for the changing of the fetching order, the processor is further configured to:
fetch first data from among the data, and
fetch second data adjacent to the first data to a location away from the first data by a distance determined based on the observation range and the size of the buffer.

9. The apparatus of claim 8, wherein, for the fetching of the second data, the processor is further configured to fetch the second data adjacent to the first data to the location away from the first data by the distance, wherein the distance is determined based on a value obtained by dividing the size of the buffer by the observation range.

10. The apparatus of claim 9, wherein the distance is determined to be a floor function value of the value obtained by dividing the size of the buffer by the observation range.

11. The apparatus of claim 1, wherein the first multiplexer is further configured to multiplex a number of pieces of the data determined based on the observation range and the size of the buffer.

12. The apparatus of claim 11, wherein the number of pieces of the data is determined based on a value obtained by dividing the size of the buffer by the observation range.

13. A processor-implemented neural network operation method, comprising:
storing data for a neural network operation in a buffer;
changing a fetching order of the data based on a total number of pieces of the stored data and an observation range for fetching the data; and
primarily multiplexing at least a portion of the data the fetching order of which is changed.

14. The method of claim 13, wherein the observation range comprises a first observation range for observing data of different channels and a second observation range for observing data of the same channel.

15. The method of claim 14, wherein
the first observation range is a look-ahead observation range, and
the second observation range is a look-aside observation range.

16. The method of claim 13, further comprising:
secondarily multiplexing the primarily multiplexed data.

17. The method of claim 16, further comprising:
performing a multiply-accumulate (MAC) operation on the secondarily multiplexed data.

18. The method of claim 16, wherein the secondarily multiplexing comprises secondarily multiplexing a number of pieces of the data determined based on a first observation range for observing data of different channels and a second observation range for observing data of the same channel.

19. The method of claim 13, wherein the primarily multiplexing is performed by first multiplexers, the number of first multiplexers being determined based on a first observation range for observing data of different channels.

20. The method of claim 13, wherein the changing comprises:
fetching first data from among the data; and
fetching second data adjacent to the first data to a location away from the first data by a distance determined based on the observation range and the total number of pieces of stored data.

21. The method of claim 20, wherein the fetching of the second data comprises fetching the second data adjacent to the first data to the location away from the first data by the distance, wherein the distance is determined based on a value obtained by dividing the total number of pieces of stored data by the observation range.

22. The method of claim 13, wherein the primarily multiplexing comprises primarily multiplexing a number of pieces of the data determined based on the observation range and the total number of pieces of stored data.

23. The method of claim 22, wherein the number of pieces of the data is determined based on a value obtained by dividing the total number of pieces of stored data by the observation range.

24. A neural network operation apparatus, comprising:
a buffer configured to store data for a neural network operation;
one or more first multiplexers each configured to multiplex a number of pieces of the data, the number of pieces being equal to a floor function value of a division of a size of the buffer by an observation range for fetching the data.

25. The apparatus of claim 24, further comprising a processor configured to change a fetching order of the data based on the size of the buffer and the observation range.
